(19) United States
(12) Patent Application Publication
(10) Pub. No.: US 2011/0214595 A1
(43) Pub. Date: Sep. 8, 2011

(54) SAIL AND METHOD OF MANUFACTURE THEREOF

(76) Inventor: Aaron Kiss, Fort Lauderdale, FL (US)

(21) Appl. No.: 12/718,669

(22) Filed: Mar. 5, 2010

(51) Int. Cl. B63H 9/06; B29C 65/02; B29C 65/52

(52) U.S. Cl. 114/102.31; 156/285

(57) ABSTRACT

A sail includes at least two layers of durable sailcloth material (e.g., Mylar), a scrim of load bearing yarns arranged in predetermined load path orientations, and at least one heat-activated adhesive layer securing the layers of material to the scrim, such that the scrim is positioned between the layers of material. At least one of the layers of material includes visible content on an outside surface thereof. The visible content is preferably applied to the outside surface(s) of the layer(s) of material using dye sublimation to provide durable imaging. An opaque layer may be optionally included between the two outer layers of material to prevent the passage of light through the sail. Alternatively, the adhesive layer(s) may be dyed or otherwise colored to effectuate an opaque layer. The sail is preferably manufactured using a high temperature, vacuum lamination process to mitigate the quantity of voids between the layers of material.

### CROSS-REFERENCE TO RELATED APPLICATIONS

This application claims priority under 35 U.S.C. §119(e)(1) upon U.S. Provisional Application Ser. No. 60/209,477, which was filed on Mar. 6, 2009, is entitled “Sail and Method of Manufacture Thereof,” and is incorporated herein by this reference.

### BACKGROUND OF THE INVENTION

1. Field of the Invention

The present invention relates generally to aerodynamic lift devices and, more particularly, to sailboat sails adapted to bear digitally imaged informational content.

2. Description of Related Art

Competitive sailboat racing enthusiasts consider the weight on sailboats very important, especially in the rigging and sails. At the same time, sailing has become commercialized with the addition of lucrative sponsorships. Combining the lightest sails with the sponsor's desire to have digital imaging capabilities has been impossible without adding a secondary process and materials to sail manufacturing. For example, traditional forms of secondary imaging on sailboat sails include adding dies, stickers, pressure sensitive adhesives, tapes and inks to provide limited image, logo or photo recreation. However, such secondary processes and materials add undesired weight and additional layers to the sail, thereby negatively affecting the performance of the original product. Additionally, the use of such secondary processes often results in sails that display reversed images faded and backwards due to visible light penetration through the finished sailcloth, as well as limited photographic qualities.

Therefore, a need exists for a method of adding viewable informational matter to a racing sail without altering the performance of the sail.

### SUMMARY OF THE INVENTION

It is, therefore, one object of the present invention to provide a competition-quality racing sail adorned with high resolution and photorealistic informational matter without compromising performance ability of the racing sail, which may be a Mylar-laminated sail. It is another object of the present invention to provide a method for fabricating a competition-quality sail that includes and displays high resolution and photorealistic informational matter without compromising performance ability of the racing sail. It is a further object of the present invention to provide a sailboat that includes one or more competition-quality sails adorned with high resolution and photorealistic informational matter.

These and other objects are accomplished through the manufacture and use of one or more sails, which have imprinted thereon visible or viewable content, such as consumer advertising. Portions (e.g., outer layers) of the sail material are chosen by thickness and facilitate use of large printing apparatuses that can produce very large, photorealistic imagery, such as product photographs and logos. Past attempts to print, paint, stick or otherwise dispose such images upon sails having “draft” (i.e., sails which have more linear feet of sail material between the luff and the leech than the actual distance between the luff and the leech) have invariably resulted in distorted images as the draft of the sail opens up under wind loading. The present invention allows for imaged layers to be supplied in one consistent sheet or in pieces that can be attached together to form the desired airfoil shape on either flat paneled sails or sails built upon variable three-dimensional molds.

The final image can be pre-printed on external layers or sheets before the primary lamination process or can be included in the heat and pressure lamination of the layers of the sail. Alternatively, the image can be added to the finally assembled sail if the sail includes the necessary external layers.

Additional fittings in sail manufacturing, such as batten pockets and corner reinforcing patches, need special attention. In an attempt to not disturb the final image or images on the external layers of the sailcloth, these fittings may be separately imaged and affixed to the final membrane with matching imaging in place to align without being visible to the casual viewer. The proper imaging and installation of these final pieces is necessary to display a continual image, brand message or design.

When the external sheets or layers of the sail material are laid flat upon a horizontal planar surface, they can be printed upon or dye sublimated to add the visible or viewable content. Since some sails are larger than existing printers can accommodate due to the flattened nature of the material, plural sheets can be printed upon and combined, such as by stitching, pressurized heat seaming, taping or otherwise combining, along edges of the sheets so as to be used to form the entire sail. In use, a “draft” is created in the sail by aerodynamic forces causing the sail to assume an airfoil shape which drives the vessel through the water. Batten pockets or other fittings covered with artwork or other viewable matter corresponding to those sections of the sail where such fittings are desired may be combined with the adorned, outer sail layers, such as by stitching, heat seaming, taping or otherwise combining.

The use of materials chosen from the group of materials disclosed herein has exhibited the result of performance comparable to standard Mylar, Kevlar, etc. sails, but upon which can be printed or otherwise imparted detailed, photo-realistic images of products and/or other informational content which is visible on a sailing vessel.

There is also disclosed herein a novel method for manufacturing a high performance sail. In one embodiment, the method includes: (a) providing a first layer or sheet of a durable sailcloth material (e.g., clear, white or colored Mylar) imaged on one side with first informational, graphic and/or other visible content, (b) disposing a first heat-activatable adhesive layer to the other side of the first layer, (c) positioning the first layer on a horizontal surface or a variable three-dimensional mold with the first adhesive layer facing upwards, (d) positioning a plurality of load bearing yarns upon the first adhesive layer in predetermined load path orientations, (e) providing a second layer of durable sailcloth material (e.g., Mylar) imaged on one side with second visible content, (f) disposing a second heat-activatable adhesive layer onto the other side of the second layer, (g) positioning the second layer such the second adhesive layer faces the positioned load bearing yarns, wherein at least the first layer, the first adhesive layer, the plurality of load bearing yarns, the second layer and the second adhesive layer form a sail arrangement, (h) positioning the sail arrangement into a vacuum, and (i) applying appropriate heat and pressure to the sail arrangement while the sail arrangement is in the vacuum to activate at least the first and second adhesive layers and to mitigate a quantity of voids within the sail.

In an alternative embodiment, one or more dark-colored (e.g., black or charcoal gray), opaque layers or sheets may be added between the two exterior or outer layers (e.g., where the outer layers are white or clear) to substantially reduce the amount of light that can pass through the sail and thereby more effectively prevent the image on the first layer from being seen from the second layer, and vice versa. In such a case, the opaque layer(s) or sheet(s) would be positioned upon the load-bearing yarns or between the yarns and one or both outer sheets. Further, one or more additional layers of heat-activatable adhesive may be affixed or disposed upon one or both sides of the opaque layer(s) to enable the opaque layer(s) to attach to the two outer layers and the load bearing yarns. The yarns can be comprised of Carbon Fiber, Spectra, Nylon, Kevlar, Mylar and other natural and polymeric fibers.

In yet another embodiment, the inside surface of one or both outer layers may be printed, dyed or otherwise colored with a dark color (e.g., grey or black) to form one or more opaque layers instead of inserting a separate opaque sheet in between the load-bearing yarns and the second outer layer, particularly where the outer layers are white or clear. When included, the opaque layer(s) may be sized to coincide with the sizes of the outer layers or may be sized and arranged to reside behind only portions of one or both of the outer layers (e.g., the portions containing the visible content on one or both outer layers). The opaque layer(s) may also or alternatively be implemented using a tinted adhesive layer between one or both outer layers.

The improvement in sail manufacturing provided by the present invention will enable sail manufacturers to supply their sailboat racing customers with a product with the same attributes as current racing technology but with a durable image that sponsors will be attracted to utilize in an effort to increase their exposure by displaying photo-quality recreations of products, messages, or other visible content.

The imaging of the Mylar or other durable sailcloth with the visible content is preferably performed prior to assembly of the sail arrangement (which may be the entire sail or a portion thereof, such as when the sail is too large to print or otherwise image all at once), but may alternatively be performed after sail assembly should the outer sheets or layers already be cut into the shape of a sail. Thereafter, printed batten pockets and reinforcement patches, grommets, reefing lines, etc. can be attached.

In one embodiment, the sail manufacturing method of the present invention may be integrated into existing sail manufacturing methods, such as those described in U.S. Pat. Nos. 4,831,953, 4,624,205, and 4,593,639 with the specific changes discussed above and below.

The present invention can be best understood with reference to the accompanying drawings and from a consideration of the following detailed description in which corresponding parts are indicated by corresponding reference numerals.

### BRIEF DESCRIPTION OF THE DRAWINGS

FIG. 1 is a perspective view of an exemplary racing sailboat employing sails produced in accordance with one embodiment of the instant invention.

FIG. 2 is a perspective view of a sheet of Mylar or similar material being imaged with visible content prior to sail assembly in accordance with one embodiment of the present invention.

FIG. 3 is an exploded, perspective view of various layers of a sail in accordance with one embodiment of the present invention.

FIG. 4 is a block diagram illustrating final stages of assembly of a sail in accordance with one embodiment of the present invention.

FIG. 5 is an exploded, perspective view of imaged fittings that strengthen the sail at high load areas and reef points and facilitate use of battens in “batten pockets” without altering the visible image, in accordance with one embodiment of the present invention.

### DETAILED DESCRIPTION

The present invention is directed to a multi-layer, laminated sailboat sail providing high quality, durable imaging on both sides thereof, a sailboat that utilizes one or more such sails, and a method for manufacturing such a sail. In one embodiment, a high performance sailboat sail is constructed using Mylar laminated sail manufacturing processes that are altered by changing layer materials, and optionally at least a portion of the overall sailcloth arrangement, to allow for digital imaging without adding an external image layer, without increasing weight, without distorting shape, and while generally maintaining current industry manufacturing protocols. The sail is constructed by utilizing white Mylar or similar film to allow for CMYK (cyan (C), magenta (M), yellow (Y) and black (K)) and RBG (red (R), blue (B) and green (G)) color separation techniques in digital imaging. The image may be applied to the film using large format printers or dye sublimation technology. An optional, but preferred, addition to the conventional sail lamination manufacturing process is the inclusion of an opaque (preferably 100% opaque) Mylar film or other opaque layer between the external film layers. The imaging may be affixed or applied to the external layers before, during or after lamination of the sail's layers creating a single membrane.

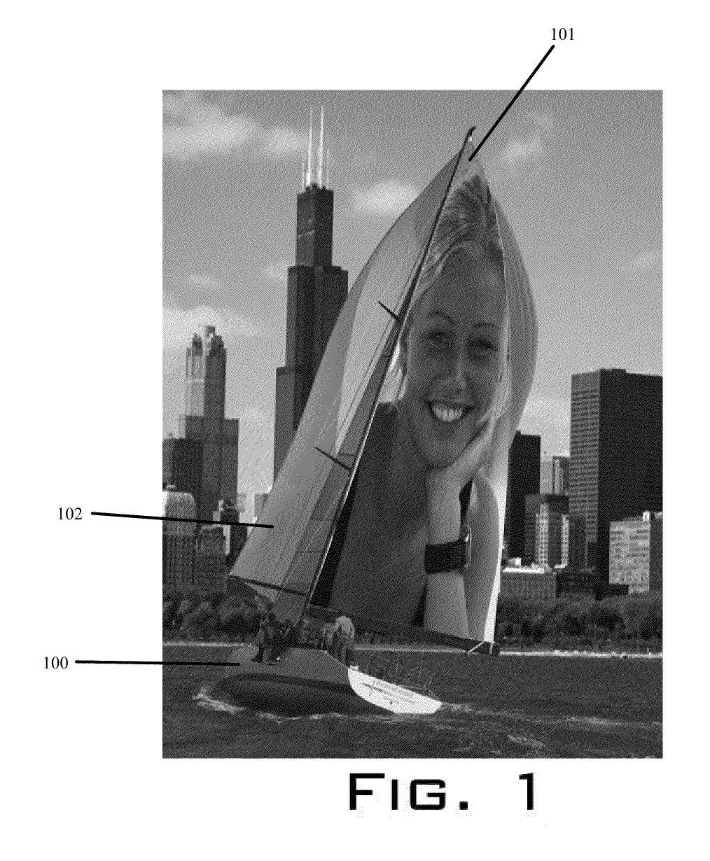

FIG. 1 depicts a racing sailboat 100 in accordance with one embodiment of the present invention. As depicted, the sailboat 100 includes a main sail 101 and a jib sail 102. In this embodiment, the main sail 101 is fabricated to include visible content (e.g., a photograph, a corporate logo, a slogan, an advertisement, or any other visually-recognizable content); whereas, the jib sail 102 is not. In an alternative embodiment, the jib sail 102 may also or alternatively include visible content and be fabricated as described herein.

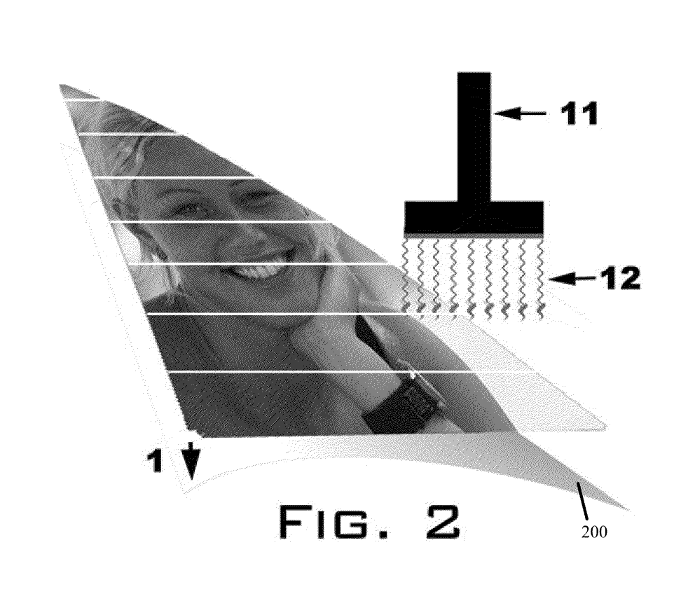

FIG. 2 is a perspective view of a sheet 200 of Mylar polyester or similar material being imaged with visible content 1 prior to sail assembly in accordance with one embodiment of the present invention. In particular, FIG. 2 illustrates direct or indirect digital imaging being affixed to or disposed on a sheet 200 of Mylar polyester or other durable sailcloth material capable of being used in a competitive racing environment. At least three different processes can be utilized to directly or indirectly affix the visible content 1 to the sheet 200. For example, two direct ways are soluble ink printing and UV cured ink applications. Soluble ink printing may be done by a 16½ foot wide Large Format Printer, such as the Vutek 5300 printer. The soluble ink is designed with chemicals that permeate the surface of the sheet 200 to provide a durable image. However, soluble ink printing typically requires application of a liquid top coating of an ultraviolet (UV) ray inhibitor to protect the imaged content against fading when exposed for long durations to sunlight.

The second way to directly image onto the sheet 200 is to use UV cured ink applications, such as provided by Hewlet Packard large format printers. Such UV cured ink applications provide faster drying times and durable imaging, and do not require the additional application of liquid top-coating or UV inhibitors, as may otherwise be necessary when using other large format printers.

The final and more preferred image affixation process is an indirect image application in the sense that it is a dying process using dye sublimation technology. This process uses heat 12 and pressure 11 to create microscopic bubbles or pores in the surface of the sheet 200 and then transfer the inks from a solid state directly to a gas state to fill the open microscopic pores with the exact color from a transferring medium, which was first imaged upon backwards to end up with a correctly facing image 1 upon completion of the dye sublimation. The heat 12 is removed and the pores close trapping the gassed inks that stick to the sides of each pore. This preferred process offers an extremely durable image that cannot be scraped off and can only be removed by destroying the integrity of the sheet 200 itself. Use of large format printers utilizing soluble inks or UV cured inks, or dye sublimation transfer technology systems ensure a durable image is imprinted on or otherwise affixed to the sheet 200.

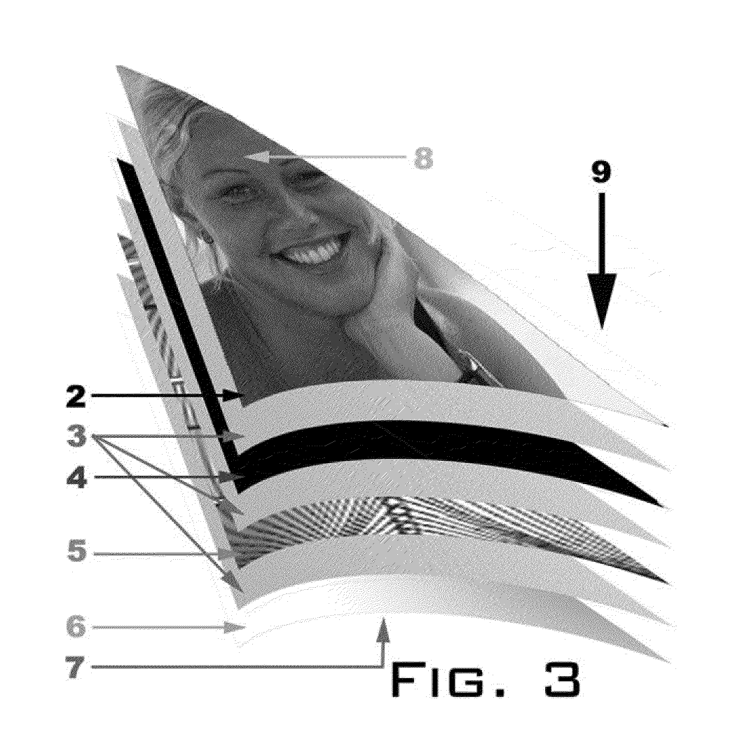

FIG. 3 is an exploded, perspective view of various layers of a sail 9 in accordance with one embodiment of the present invention. In particular, FIG. 3 shows the layers in an exemplary order of assembly including heat-activatable adhesive layers 3 positioned between each substantive layer 2, 4, 5, 6. However, those of ordinary skill in the art will readily recognize and appreciate that the order of assembly of the layers 2, 4, 5, 6 may vary form that described below. In one embodiment, the sail 9 is assembled by first imaging visible content 8 on an outward-facing surface 7 of one layer 6 using, for example, the dye sublimation process disclosed above when visible content is desired for such surface 7. Next, the imaged layer 6 is placed on a flat surface or is positioned into an airfoil shape through use of an array of varying height jacks as known in the art. An adhesive layer 3 of thermoplastic hot-melt adhesive is disposed on the inward-facing surface of layer 6 and a scrim layer 5 is positioned on the adhesive layer 3. The scrim layer 5 includes yarns applied in a predetermined arrangement to take into account the expected wind loads to be encountered during use; thus, the volume and orientation of the yarns may vary greatly across the area of the sail 9. For example, sections of the sail 9 expected to bear greater wind load may have a higher density of yarns than other sections of the sail 9. Additional yarns may be added in such high load sections in order to address secondary loads while subjecting the sails to unpredictable wind forces.

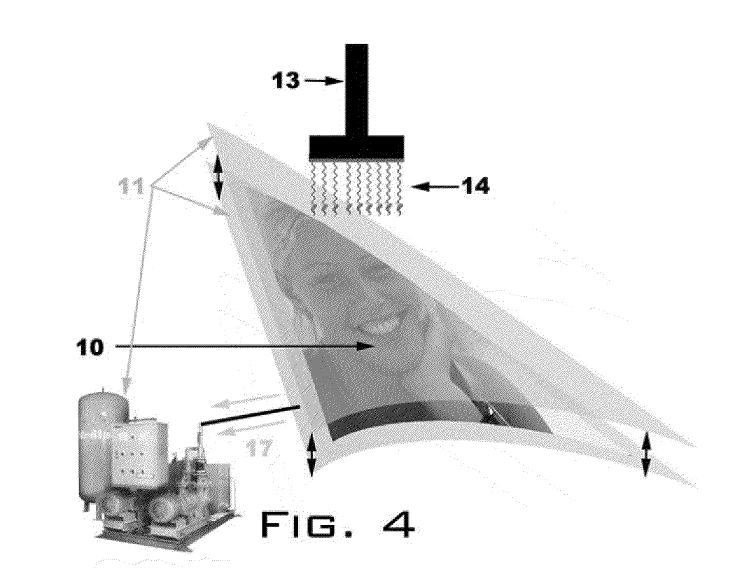

Another adhesive layer 3 is added or applied over the scrim layer 5. An optional opaque (preferably black or grey) layer 4, when included, is positioned on the scrim's adhesive layer 3 or, instead of applying an adhesive layer 3 over the scrim 5, such adhesive layer 3 may be more readily applied to the surface of the opaque layer 4 which will face the scrim layer 5. Alternatively, the adhesive layer 3 may be colored to effectuate or implement the opaque layer 4, when desired, and thereby eliminate the weight of the extra (e.g., Mylar) opaque sheet. Another adhesive layer 3 is either applied to the non-scrim side of the opaque layer 4 (when included) or to the inward-facing surface of the other outer layer 2. Then, outer layer 2 is positioned atop the opaque layer 4 or the scrim layer 5, as applicable, depending on whether the opaque layer 4 is included. When outer layer 2 (top layer as shown in FIG. 3) includes visible content 8, such content may be pre-applied to the outward-facing surface of the layer 2 using dye sublimation or a direct imaging process as described above. After the sail's layers have been arranged as described above, the layers are attached to one another as detailed below with respect to FIG. 4.

In the foregoing embodiment, the sail 9 is configured with imaging on both outer surfaces of the final laminated sail membrane 9. In an alternative embodiment, the visible content may be imprinted on only one outer surface of the assembled membrane 9. Alternatively, different visible content may be imaged on the two outer surfaces of the final sail membrane 9 or similar content may be imaged on both sides so as to read properly from either side of the sail 9. Those of ordinary skill in the art will readily recognize and appreciate that countless imaging possibilities exist in accordance with the present invention and all such possibilities are intended to be covered within the scope of the invention.

FIG. 4 is a block diagram illustrating final stages of assembly of a sail 9 in accordance with one embodiment of the present invention. In particular, FIG. 4 shows the steps in the process of laminating the layers 2-6 together in an attempt to make the final membrane 9 durable. In the illustrated system, a vacuum bag 11 is placed around the assembled layers 2-6 and attached to a vacuum pump 17. The vacuum pump 17 removes most all of the air within the bag 11 and the sail layers 2-6 and minimizes the voids between the layers 2-6. Heat 14 and pressure 13 are applied in combination with the vacuum to cause the adhesive layers 3 to activate and secure the layers 2, 4, 6 and the scrim layer 5 together. The described lamination process may take place on a three-dimensional molded surface prepared to mimic the final desired airfoil shape. Alternatively, the lamination process may be performed on a flat surface and the resulting flat panels may be joined using known crosscut and/or broadseaming techniques.

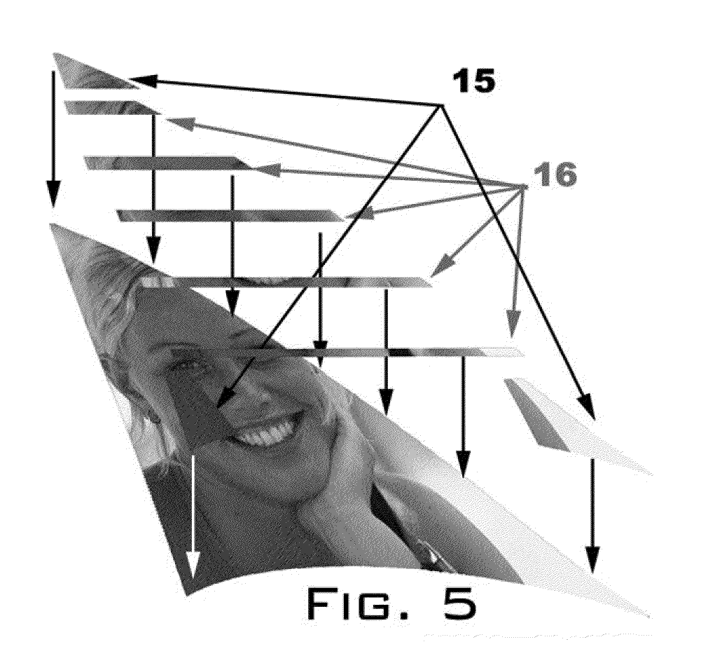

FIG. 5 is an exploded, perspective view of imaged fittings 15, 16 that strengthen the sail at high load areas and reef points and facilitate use of battens in “batten pockets” 16 without altering the visible image, in accordance with one embodiment of the present invention. In particular, FIG. 5 shows pre-imaged attachments 15, 16 that are sometimes necessary in sail manufacturing to prepare a sleeve 16 where any battens (sail support rods) need to be inserted and to provide reinforcement patches 15 in high load areas at the head, clew and tack of the sail and/or where reef points lay which are used to shorten the sail 9 or reduce sail area in high wind conditions. By preprinting these pieces and affixing them where they visually match, no interruption of the visible image or content occurs, thereby retaining a continuous image on one or both sides of the laminated sail 9.

In addition, various fittings and other hardware (e.g., grommets, leach lines, batten cars, track cars, head boards, webbing, chafe protectors, etc.) may be affixed to or associated with the sail 9 as needed to attach the sail 9 to a sailboat 100 and make the sail 9 and the sailboat 100 completely functional.

### Example

In one exemplary embodiment, a sail 9 in accordance with the instant invention is manufactured with two sheets 2, 6 of white Mylar Film from Dupont Tiejin Films with imaging/visible content 1 pre-affixed using dye sublimation technology. In the exemplary embodiment, the thickness of the Mylar for both the white Mylar sheets 2, 6 and the optional black Mylar sheet 4 is approximately 0.1 mil to 1.0 mil (approximately 0.002 to 0.020 millimeters) in thickness. Alternatively, other thicknesses of the Mylar may be used as desired for the particular sailing application. The finished sail 9 includes at least two sheets 2, 6 of white Mylar sandwiching a scrim 5 of yarns placed in a load bearing fashion commonly referred to as Load Path technology. The yarns used to form the scrim 5 may consist of different materials including, but not limited to, carbon fiber yarns, Spectra yarns, nylon yarns, Vectran yarns, and other yarns commonly used in the manufacture of high performance sails. The bonding agent or adhesive layers 3 are a heat-activatable adhesive that is sprayed on to the sheets 2, 6 of Mylar and is activated at time of lamination (as shown in FIG. 4) under either infra-red or conductive heat ranging from 200-400 degrees Fahrenheit with a minimum vacuum pressure of one atmosphere. An optional, but preferred, opaque light barrier sheet or layer 4 may be inserted between the scrim 5 and at least one of the sheets 2, 6 of white Mylar to prevent light from passing through the sail 9. Other external pre-imaged pieces may be added as necessary by traditional means (e.g., as illustrated in FIG. 5) to facilitate the use of batten pockets 16, reinforcement patches 15 and other fittings as may be necessary to sail a boat in racing conditions.

The sail 9 includes visible content 1, 8 on the outer surface of one or both sides of the assembled sail membrane 9 as illustrated in FIGS. 1 and 3. The visible content may be textual informational matter, images, logos, slogans, photographs, any combination thereof, or any other visible or viewable content. Additionally, the visible content 1, 8 can be pre-printed on the outer layers 2, 6 before the primary lamination process or can be included in the heat and pressure lamination of the layers of the sail 9. Alternatively, the visible content 1, 8 can be added to the finally assembled sail 9. The sail 9 is ideally suited for advertisement or sponsorship promotion when utilized on near-shore sailing vessels or racing sailboats with large media exposure. The final membrane 9 is preferably partially or fully opaque such that matter 8 printed on one side of the sail 9 will not show through to the other side when viewed in sunlight. Such opaqueness facilitates printing of independent matter on either side of the sail 9.

As an example, but not by way of limitation, the above-described sail manufacturing process can be used for any sail on any vessel, including, but not limited to, main sails, jib sails, top sails, square sails, gaff rigged sails, roller furling sails, hanked on sails, racing sails, cruising sails and other sails.

This new technology allows for images on both sides to read in a properly oriented presentation or the imaging of two completely different images to be placed on either side of a sail without the worry of sunlight penetration mixing the two images on either side of the sail. Furthermore, the manufacturing process disclosed herein is integratable into current sail-making processes to provide photo-quality imaged sails without the need for secondary, post fabrication processing.

This technology offers sponsors of sailing events and sailing crafts a more noticeable and recognizable reproduction of their message, slogan or branding message readable from longer distances. Furthermore, this method allows sponsors flexibility in the visual representation of their company's logos, brands, image, or product representation. Additionally, steps are taken to supply supplementary or ancillary pieces, such as batten pockets and corner reinforcements, without compromising the integrity of the viewable content.

The instant invention has been disclosed above in exemplary embodiments to facilitate an understanding thereof. However, the invention is not restricted to the illustrative examples described above and illustrated in the drawings, but may be modified without departing from the intended scope of the invention.

What is claimed is:

1. A method for fabricating at least part of a sailboat sail, the method comprising:
providing a first layer of a durable sailcloth material having a first side and an opposing second side, the first layer of material including first dye sublimated, visible content on the first side thereof;
disposing a first heat-activatable adhesive layer onto the second side of the first layer of material;
positioning the first layer of material on a support structure with the first adhesive layer facing upwards;
positioning a plurality of load bearing yarns upon the first adhesive layer in predetermined load path orientations;
providing a second layer of the durable sailcloth material having a first side and an opposing second side;
providing a second heat-activatable adhesive layer;
positioning the second layer of material upon the first layer of material such the second adhesive layer is positioned between the first side of the second layer of material and the plurality of load bearing yarns, wherein at least the first layer of material, the first adhesive layer, the plurality of load bearing yarns, the second layer of material, and the second adhesive layer form a sail arrangement;
positioning the sail arrangement into a vacuum; and
applying appropriate heat and pressure to the sail arrangement while the sail arrangement is in the vacuum to activate at least the first and second adhesive layers and to mitigate a quantity of voids between the first layer of material and the second layer of material.

2. The method of claim 1, further comprising:
positioning an opaque layer between the second adhesive layer and the first side of the second layer of material; and
providing a third heat-activatable adhesive layer between the opaque layer and the first side of the second layer of material,
wherein at least the first layer of material, the first adhesive layer, the plurality of load bearing yarns, the second layer of material, the second adhesive layer, the opaque layer, and the third adhesive layer form the sail arrangement.

3. The method of claim 1, wherein providing a second heat-activatable adhesive layer comprises:
disposing the second adhesive layer on the first side of the second layer of material.

4. A sailboat sail formed by a process comprising:
providing a first layer of a durable sailcloth material having a first side and an opposing second side, the first layer of material including first dye sublimated, visible content on the first side thereof;
disposing a first heat-activatable adhesive layer onto the second side of the first layer of material;
positioning the first layer of material on a support structure with the first adhesive layer facing upwards;
positioning a plurality of load bearing yarns upon the first adhesive layer in predetermined load path orientations;
providing a second layer of the durable sailcloth material having a first side and an opposing second side;
providing a second heat-activatable adhesive layer;
positioning the second layer of material upon the first layer of material such the second adhesive layer is positioned between the first side of the second layer of material and the plurality of load bearing yarns, wherein at least the first layer of material, the first adhesive layer, the plurality of load bearing yarns, the second layer of material, and the second adhesive layer form a sail arrangement;
positioning the sail arrangement into a vacuum; and
applying appropriate heat and pressure to the sail arrangement while the sail arrangement is in the vacuum to activate at least the first and second adhesive layers and to mitigate a quantity of voids between the first layer of material and the second layer of material.

5. The sail of claim 4, wherein the first and second layers of material are white sheets of Mylar.

6. The sail of claim 4, further including an opaque layer positioned between the second adhesive layer and the second side of the second layer of material.

7. The sail of claim 4, wherein at least one of the first adhesive layer and the second adhesive layer is opaque.

8. The sail of claim 4, wherein the second layer of material includes second dye sublimated, visible content on the second side thereof.

9. A laminated sail comprising:
a first layer of a durable sailcloth material having a first side and an opposing second side, the first layer of material including first dye sublimated, visible content on the first side thereof;
a second layer of the durable sailcloth material having a first side and an opposing second side;
a plurality of load bearing yarns arranged in predetermined load path orientations, wherein the plurality of load bearing yarns are positioned between the second side of the first layer of material and the first side of the second layer of material; and
at least one heat-activated adhesive layer securing the second side of the first layer of material, the first side of the second layer of material, and the plurality of load bearing yarns.

10. The sail of claim 9, wherein the second layer of material includes second dye sublimated, visible content on the second side thereof.

11. The sail of claim 9, further comprising:
at least one opaque layer positioned between the second side of the first layer of material and the first side of the second layer of material.

12. The sail of claim 9, wherein the at least one adhesive layer is opaque.

13. The sail of claim 9, wherein the first and second layers of material are sheets of Mylar.

14. The sail of claim 9, wherein the visible content includes at least one of textual informational matter, images, logos, slogans, and photographs.

15. The sail of claim 9, wherein the first and second layers of material are white.
